(19) United States
(12) Patent Application Publication
(10) Pub. No.: US 2007/0027944 A1
(43) Pub. Date: Feb. 1, 2007

(54) Instruction based parallel median filtering processor and method

(76) Inventors: James Wilson, Foxboro, MA (US); Joshua Kablotsky, Carlisle, MA (US); Yosef Stein, Sharon, MA (US); Gregory M. Yukna, Norton, MA (US)

Correspondence Address: Iandiorio & Teska, 260 Bear Hill Road, Waltham, MA, 02451-1018, US

(21) Appl. No.: 11/191,513

(22) Filed: Jul. 28, 2005

(51) Int. Cl. G06F 17/10

(52) U.S. Cl. 708/300

(57) ABSTRACT

An instruction based parallel median filtering processor and method sorts in parallel each combination of pairs of inputs into greater and lesser values; determines from that sorting the minimum, maximum and median filter values of the inputs; and applies at least one instruction for enabling indication of at least one of the maximum, minimum, median filter values.

### FIELD OF THE INVENTION

This invention relates to an instruction based parallel median filtering processor and method.

### BACKGROUND OF THE INVENTION

Median filtering is a non-linear signal enhancement technique for the smoothing of signals, the suppression of impulse noise, and preserving of edges. It consists of sliding a window of an odd number of elements along the signal and replacing the center sample by the median of the samples in the window. The median value m of the samples in a window is the value for which half of the samples in the window have smaller values then m and the other half have values greater than m. In a one dimensional median filter having three samples P1, P₂, P₃; the median value is found by sorting the three samples and selecting the mid point as the median. In the straightforward approach P2 is compared to P₃ in the first stage; the minimum of that is compared to P₁ in the second stage, and the minimum of the second stage is the P_{MIN}. In the third stage the maximum output of the second stage is compared to the maximum of the first stage. The maximum output of the third stage is P_{MAX} and the minimum output of the third stage is P_{MED}. One shortcoming of this approach is that the three stages operate sequentially; it requires three cycles of operation to obtain the median. Another problem is that each sort operation (finding the min and max between two samples) is dependent on the result of the previous one which in a deeply pipelined machine would cause pipeline stall: the pipeline will stop, waiting for the offending instruction to finish, before resuming work. A fully parallel solution that mitigates the multiple sequential operation problem uses a dedicated ASIC, which, however, embodies additional limited functionality hardware which permanently accompanies the DSP even though it may be only occasionally needed. Attempts to apply a parallel solution within the DSP that are optimized for multiply-accumulate actions as occur in FIR and FFT operations, has not been pursued because in a typical DSP where median filters are used the compute-unit result bus has only half the width of the input bus due to the fact that in multiplication of two N bit numbers the result being stored to memory is one number of N bits. In median filters, however, the three, five . . . inputs are merely sorted and result in the same number of outputs.

### SUMMARY OF THE INVENTION

It is therefore an object of this invention to provide an improved instruction based parallel median filtering processor and method.

It is a further object of this invention to provide such a improved instruction based parallel median filtering processor and method which is faster than conventional median filters and requires no additional ASIC or FPGA.

It is a further object of this invention to provide such an improved instruction based parallel median filtering processor and method which is compatible with conventional two input, one output compute-unit bus structures.

It is a further object of this invention to provide such an improved instruction based parallel median filtering processor and method which decomposes the three tap median filters into two parallel independent instructions.

It is a further object of this invention to provide such an improved instruction based parallel median filtering processor and method which removes pipeline dependency between the decomposed instructions.

It is a further object of this invention to provide such an improved instruction based parallel median filtering processor and method which reduces the processor die area by avoiding the limited functionality hardware block required for parallel median filtering.

It is a further object of this invention to provide such an improved instruction based parallel median filtering processor and method which can employ the existing hardware components of a traditional processor.

The invention results from the realization that improved instruction based median filtering which is faster than conventional median filters, requires no additional limited functionality ASIC or FPGA, is pipeline independent and is compatible with two input, one output compute-unit bus structures can be achieved by sorting in parallel each combination of pairs of inputs into greater and lesser members, determining from that sorting the minimum, maximum and median filter values of the inputs and applying pipeline independent decomposed instructions to enable the decision circuit to indicate at least one of the maximum, minimum and median filter values in response to one instruction and the others of those values in response to another instruction.

The subject invention, however, in other embodiments, need not achieve all these objectives and the claims hereof should not be limited to structures or methods capable of achieving these objectives.

This invention features a processor with instruction based parallel median filtering including a compute unit for receiving a plurality of inputs and including a comparing circuit for sorting in parallel each combination of pairs of inputs into greater and lesser members and a decision circuit responsive to the sorting of the pairs of inputs to determine the minimum, maximum and median filter values of the inputs. A program sequencer provides an instruction for enabling the decision circuit to indicate at least one of the maximum, minimum and median field values.

In a preferred embodiment the comparing unit may include a comparator circuit for comparing each pair of the inputs. Each comparator circuit may include a subtractor circuit for subtracting each pair of inputs. The greater and lesser members of each pair may be indicated by the sign of their difference. The decision circuit may include a logic circuit responsive to the pattern of signs of the differences to indicate the median filter value. The decision circuit may include a logic circuit responsive to the pattern of signs of the differences to indicate the maximum, minimum and median filter values. The program sequencer may provide one instruction for enabling the decision circuit to indicate one of the maximum, minimum and median filter values and another instruction to indicate the others of those values. There may be three inputs

The invention also features a method of instruction based parallel median filtering in a compute unit of a processor including sorting in parallel each combination of pairs of inputs into greater and lesser values and determining from that sorting the minimum, maximum and median filter values of the inputs. There is an applied instruction for indication of at least one of the maximum, minimum and median filter values.

In a preferred embodiment there may be applied decomposed instructions for enabling indication of at least one of the maximum, minimum and median filter values in response to one instruction and the others of those values in response to another instruction. There may be three inputs.

### BRIEF DESCRIPTION OF THE DRAWINGS

Other objects, features and advantages will occur to those skilled in the art from the following description of a preferred embodiment and the accompanying drawings, in which:

FIG. 1 is an enlarged schematic view of an area of pixels to be median filtered;

FIG. 2 is a schematic diagram of a prior art three input median filter;

FIG. 3 is a truth table of the eight possible patterns of Max, Med, Min for a three input median filter;

FIG. 4 is a schematic diagram of a portion of a compute unit in a processor functioning as a median filter according to this invention;

FIGS. 5 and 6 are views similar to FIG. 4 showing a two step technique using pipeline independent decomposed instructions to accommodate to conventional processor output bus limitations;

FIGS. 7, 8 and 9 are schematic block diagrams showing median filters similar to FIG. 4 according to this invention for filtering windows or neighborhoods of five, seven and nine inputs, respectively;

FIG. 10 is a schematic diagram of a processor showing a program sequencer and compute unit for implementing this invention; and

FIG. 11 is a block diagram of the method of this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

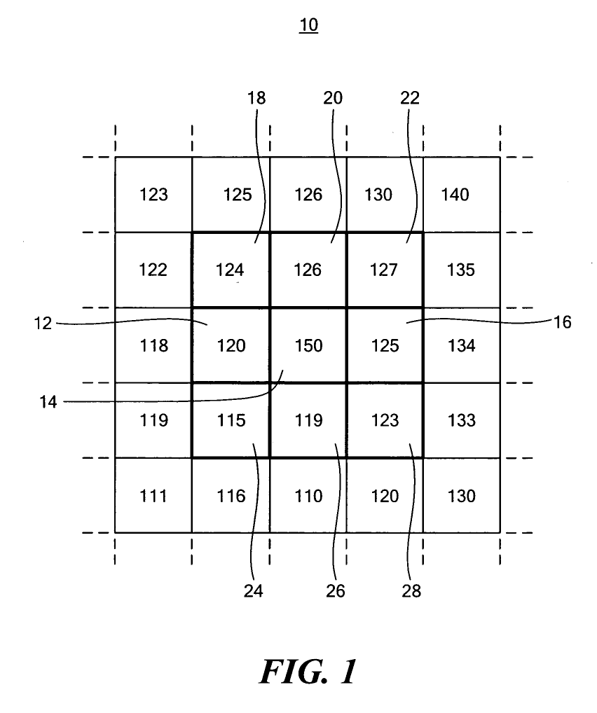

There is shown in FIG. 1 a portion of an image 10 whose pixels are to be median filtered. For example, assuming a neighborhood or window of three pixels 12, 14 and 16, representing a one dimensional signal whose values are respectively 120, 150, and 125, the median value then is 125, the minimum value is 120 and the maximum is 150. Consider a two dimensional signal including pixels 12, 14 and 16 as well as pixels 18, 20, 22 and pixels 24, 26, and 28. This is now a window or a neighborhood of nine values, namely, 115, 119, 120, 123, 124, 125, 126, 127 and 150. Clearly here the median value is 124, the minimum 115, and the maximum 150.

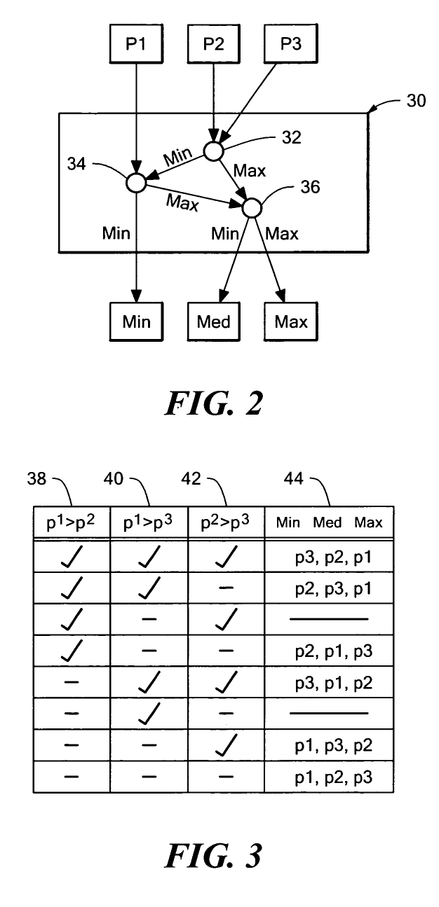

Conventional median filters, such as, median filter 30, FIG. 2, having three input taps for receiving inputs P₁, P₂, and P₃, typically include three logic stages or nodes 32, 34, and 36 to obtain three outputs Min, Med, and Max. Node 32 first compares inputs P₂ and P₃ to determine the Min and the Max. Min is delivered to node 34 where it is compared with input P₁ so that node 34 determines the Min which it outputs to be the Min of the filtering and a Max which together with the Max output from node 32 is now processed by node 36. Node 36's Max output is the Max output of the filter; its Min output is the Med output of the filter. One problem with this conventional approach is that it takes three cycles of operation. Node 34 cannot operate until it receives the results from the operation of node 32; node 36 cannot operate until it receives the results of the operations of node 34 and node 32.

In accordance with this invention it is understood that with a fixed number of inputs, for example, three, there will be a predictable number of sort patterns, each one representing a different sort pattern of inputs, P₁, P₂, and P₃ occupying the positions of Min, Med, and Max. This can be shown in the truth table of FIG. 3, which contains three columns, 38, 40 and 42, representing the three comparison combination pairs, P_{1>}, P₂; P_{1>}, P₃; and P_{2>}P₃ that can occur with three inputs. With three inputs there are eight possible combinations; a check mark in one of columns 38, 40, 42 indicates the truth of the proposition at the top of the column. For example, in the first row there are all checks because it is true that P₁ is greater than P₂, it is true that P₁ is greater than P₃ and it is true that P₂ is greater than P₃. When all three of those conditions are true it is known that P₃ will be the Min, P₂ Med and P₁ will be the Max as shown in column 44. In the next row down column 38 and 40 have a check, column 42 has a dash; the dash means that P₂ is not larger than P₃, to the contrary P₃ is larger than P₂. In that condition, then, where P₁ is larger than P₂, P₁ is larger than P₃ and P₂ is not larger than P₃, the Min, Med, Max outputs indicated in column 44 are P₂, P₃, and P₁, respectively, and so on through the eight possible combinations of the three conditions. The truth table, FIG. 3, decision column 44 shows that not all eight possible combinations are proper. For example, the third row where P₁>P₂, P₃>P₁ and P₂>P₃ is not proper because, if P₁>P₂ and P₃>P₁, it can't be that P₂>P₃.

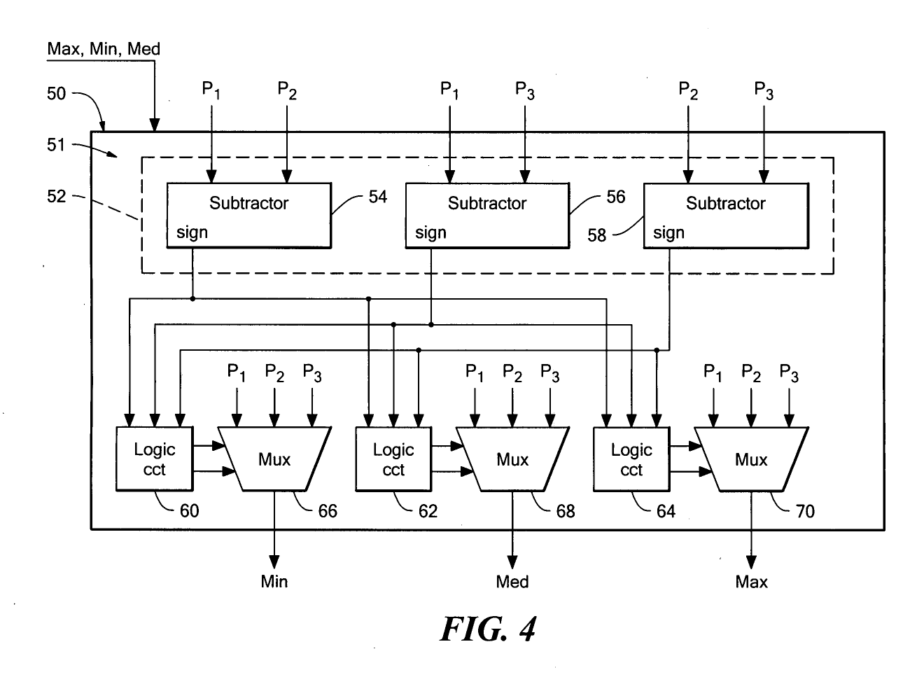

An application of the realization according to this invention is shown in FIG. 4, where a compute unit 50 includes median filter 51 including a comparing circuit 52 which includes one comparator for each pair of inputs. Those comparators may be, for example, subtractors 54, 56, and 58, one for each possible combination of the pairs of inputs, P₁ P₂; P₁ P₃; and P₂ P₃, respectively. There are many different ways that the comparison can be implemented but in this case using subtractors it can be simply accomplished by outputting the sign of the subtraction. For example, if subtractor 54 puts out a + sign, then P₁ is greater than P₂, a − sign and P₂ is greater than P₁. These + and − signs are delivered from all three subtractors, 54, 56 and 58 to the decision circuits, logic circuits 60, 62, and 64. These subtractors and logic circuits are the decision circuits which identify the Min, Med and Max. When the logic circuits recognize a pattern apparent from the truth table of FIG. 3, they pass through the associated mux 66, 68, 70 the appropriate ones of inputs P₁, P₂, P₃. For example, if the first row of the truth table in FIG. 3 is true, that is, each of the subtractors 54, 56, 58 puts out a + sign then logic circuit 60 will cause mux 66 to pass input P₁ but not inputs P₂ and P₃; logic circuit 62 will cause mux 68 to pass input P₂ but not inputs P₁ and P₃; and logic circuit 64 will cause mux 70 to pass input P₁ but not inputs P₂ and P₃. One important advantage of this approach is that instantaneously upon the appearance of the inputs P₁, P₂, and P₃ at compute unit 50, the outputs can be immediately generated from muxes 66, 68 and 70: one cycle is all that is required as contrasted with the three cycles in conventional devices.

A second problem can be addressed at the cost of only one more cycle by decomposing the instructions which operate compute unit 50. This problem arises from the fact that most processors' compute units generally have a result bus which is only half the size of the input bus. Typically, for example, the input bus would accommodate two 16 bit numbers for multiplication resulting in one 16 bit product. Here, however, three inputs of whatever size, 4 bits, 8 bits, 16 bits . . . are sorted and result in three similar outputs. To solve this problem, this invention decomposes the median filter instructions into two pipeline independent instructions.

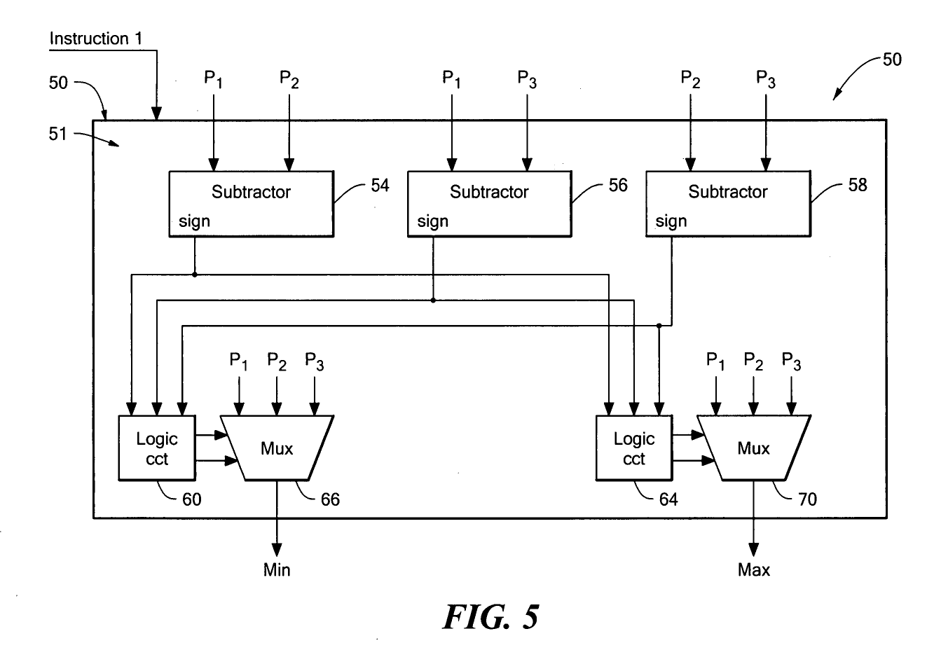

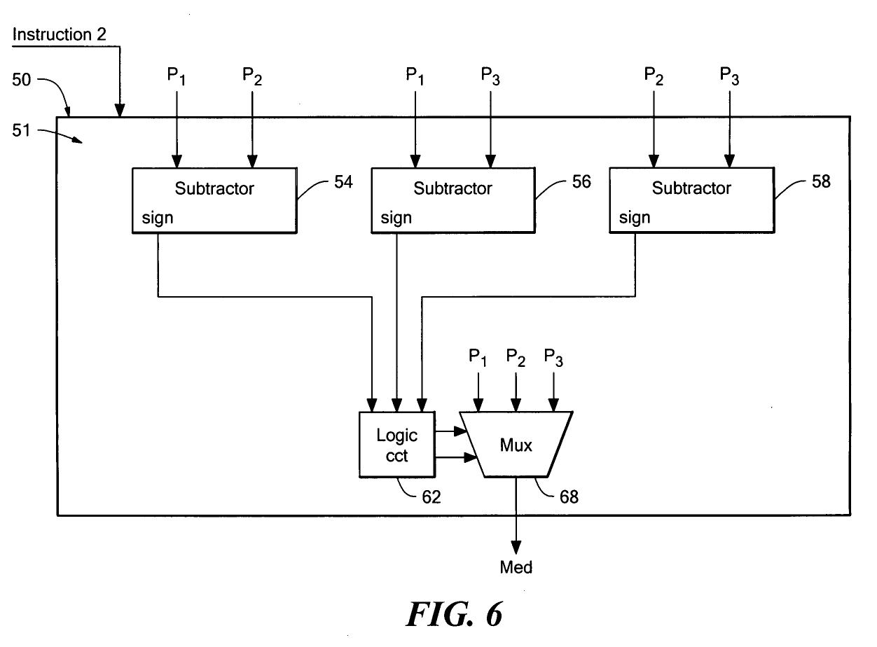

This is shown graphically in FIGS. 5 and 6, where the first instruction delivered to compute unit 50, FIG. 5, operates subtractors 54, 56, 58, logic circuits 60, 62, 64 and muxes 66, and 70 but only muxes 66 and 70, thereby passing on, for example, only the Min and Max signals. On the second instruction, FIG. 6, mux 60 is enabled to pass out the Med signal. It doesn't matter which instruction passes out which of the outputs: either instruction could put out two of the Min, Med, Max outputs and the other the remaining one. Thus, the outputs are staggered to accommodate the compute unit output bus.

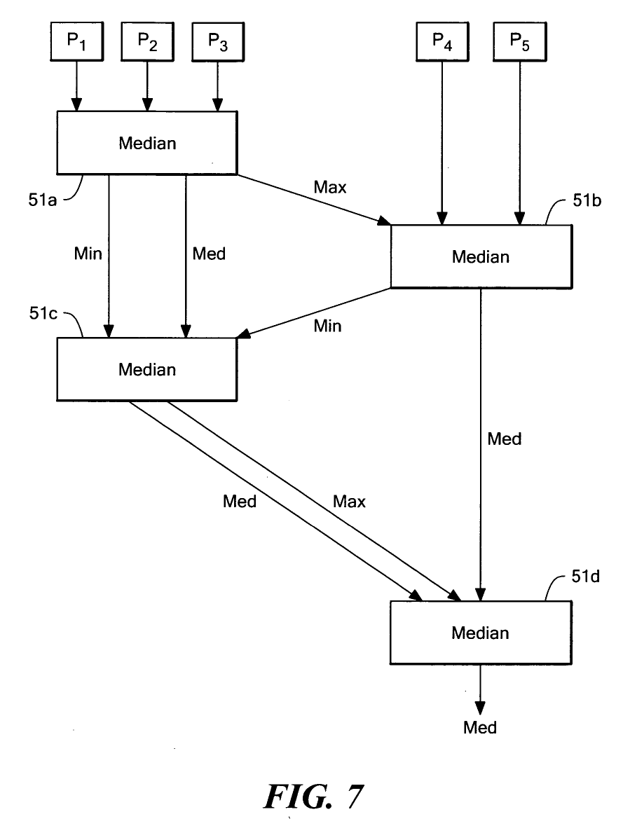

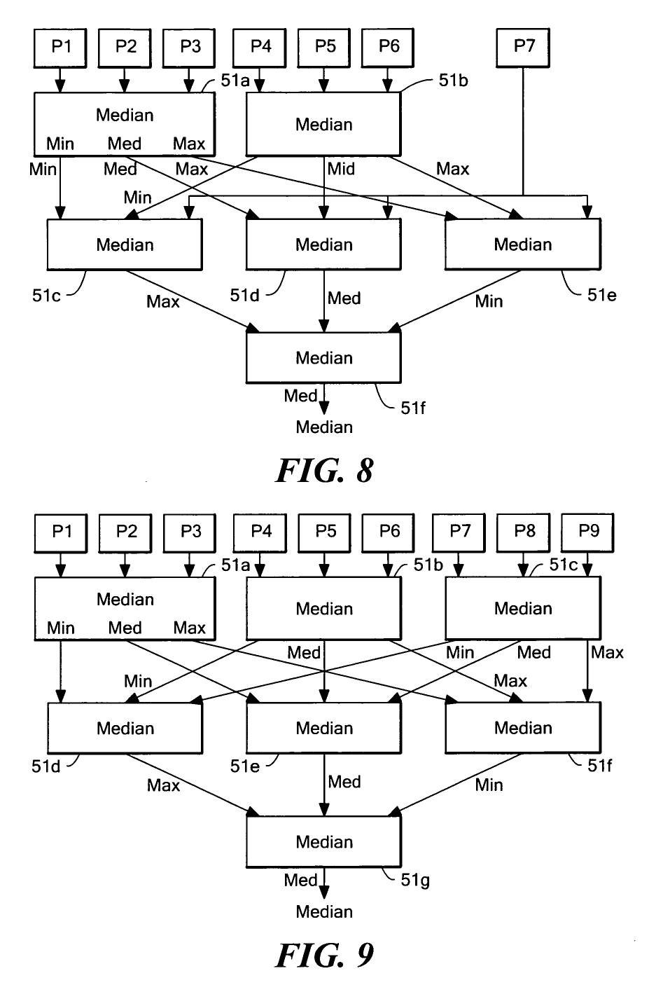

Although thus far in FIG. 1, and throughout the following explanations in FIGS. 2, 3, 4, 5, and 6, the median filter according to this invention responds only to a three input situation, this is not a limitation of the invention, for by using a plurality of such median filters carried out in a compute unit of a processor any number of inputs can be dealt with. For example, as shown in FIG. 7, there are four median filters, 51a-51d, all of which are implemented in the compute unit 50 of a processor. Median filter 51a sorts P₁, P₂ and P₃ inputs and provides a Max output to median filter 51b, and a Min and Med output to median filter 51c. Median filter 51b sorts the other two inputs P₄ and P₅ with the Max output of Median filter 51a and provides a Min output to median filter 51c and a Mid output to median filter 51d. Median filter 51c sorts the Min and Med outputs of Median filter 51a with the Min output of median filter 51b and provides Med and Max outputs to median filter 51d which also receives the Med output from median filter 51b to produce the median filter value, Med, at its Med output. Following through further examples in FIG. 8, an arrangement is shown for dealing with seven inputs, P₁-P₇ using six filters 51a-51f and FIG. 9 shows a nine input arrangement, P₁-P₉ using seven median filters 51a-51g. In each case the median filter is shown as providing only the output necessary to the particular operation but each one is capable of providing the Min, Med and Max outputs.

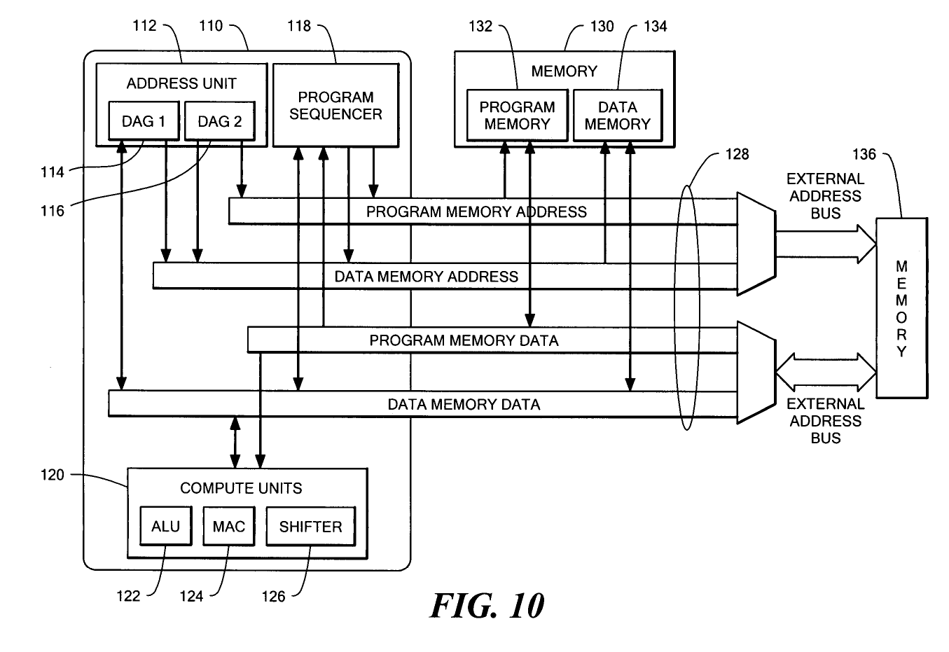

In keeping with this invention the median filters can be implemented, as explained previously, in the compute unit of a processor. Such a processor is shown in FIG. 10 as including a digital signal processor 110 including an address unit 112 having one or more data address generators 114, 116. There is a control unit, such as program sequencer 118 and one or more compute units 120, each of which contains a number of circuits such as arithmetic logic unit 122, multiply/accumulator 124, shifter 126. Typically there are two, four or many more compute units in a digital signal processor. The digital signal processor is connected over memory buses 128 to one or more memories such as level one (L1) memory 130, including program memory 132 and data memory 134 or additional memory 136. Memory 130 may be a level one memory which is typically very fast and quite expensive. Memory 136 may be a level three (L3) memory which is less expensive and slower. With DSP 110 operating at 1 GHz and beyond, the cycles of operations are so fast that the address unit and the compute units require more than one cycle to complete their operations. To improve DSP 110 throughput and enhance its performance, it is typically deeply pipelined.

The third problem of pipeline dependency can be addressed by decomposing the median filter instructions into two parallel pipeline independent instructions. In pipelined operations, when there is no dependency between the result of a previous instruction and the subsequent one across all processor parallel building blocks the pipeline efficiencies are preserved. However, if there is such a dependency a pipeline stall can happen, where the pipeline will stop and wait for the offending instruction to finish before resuming to work. Although the processor here is generally described as a digital signal processor this is not a necessary limitation as a controller, a MIPS, an ARM or any other suitable processor would be usable. The decomposed instructions for operating through the program sequencer 118 according to this invention are reproduced below:

// Initial Data Format
//
// L H L H

| | |
|---|---|
| // 72 58 17 18 | R0:R1 |
| // 9 68 118 122 | R2:R3 |
| // 120 83 67 97 | R4:R5 |

//
// Algorithm
//
// a b c d e f g h i
// \ | / \ | / \ | /
// MinMedMax MinMedMax MinMedMax Level 1
//
// 3 mins 3 Meds 3 maxs
// MinMedMax MinMedMax MinMedMax Level 2
// \ | /
// max Med min
//
// MinMedMax Level 3
// |
// Med
//
// Get the 2 Meddle values of two overlapping 3×3 arrays example code
//
// Level 1 // sort triplets

| | |
|---|---|
| r6 = MaxMin(r0, r1.1), | r9 = MaxMin(r1, r0.h); |
| r7 = MaxMin(r2, r3.1), | r10 = MaxMin(r3, r2.h); |

| | |
|---|---|
| r8 = MaxMin(r4, r5.1), | r11 = MaxMin(r5, r4.h); |
| r12.h = Med(r0, r1.1), | r12.1 = Med(r1, r0.h); |
| r0.h = Med(r2, r3.1), | r0.1 = Med(r3, r2.h); |
| r1.h = Med(r4, r5.1), | r1.1 = Med(r5, r4.h); |

```
  // Level 2
  // max of the three mins && min of the three maxs
  r3:r4 = MaxMin(r6, r7, r8)(v);
  // max of the three mins && min of the three maxs
  r5:r6 = MaxMin(r9, r10, r11)(v);
  // Get the Meds of the three Meds drop into r3.1 and r5.1
  r3:r5 = Med(r12, r10, r1)(1o, v);
  // Level 3
```

| | |
|---|---|
| // r0.h is Med | // r0.1 is Med |
| r0.h = Med(r3, r4.1), | r0.1 = Med(r5, r6.1); |

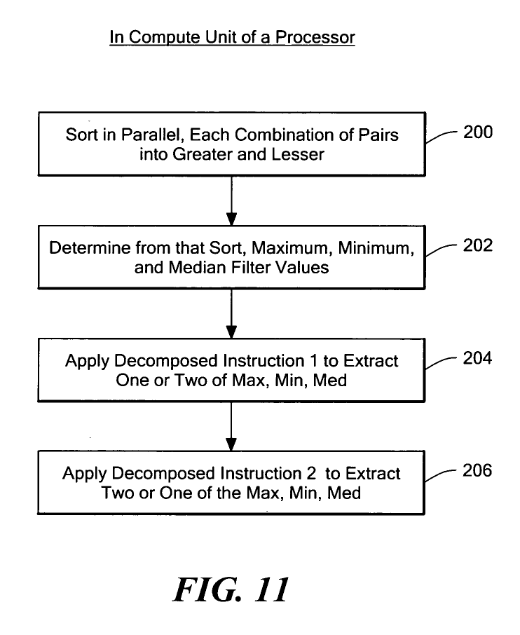

The invention is not limited to the particular hardware shown or suggested but also encompasses a method carried out in a processor, FIG. 11, which includes sorting in parallel, step 200, each combination of pairs into greater and lesser and determining, step 202, from that sort, maximum, minimum and median filter values. A final decomposed instruction is applied, 204, to extract one or two of the Max, Min, and Med values and then a second decomposed instruction, 206, is applied to extract the other remaining two or one of the Max, Min, and Med filter values.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A processor with instruction based parallel median filtering comprising:
a compute unit for receiving a plurality of inputs and including a comparing circuit for sorting in parallel each combination of pairs of inputs into greater and lesser members and a decision circuit responsive to the sorting of said pairs of inputs to determine the minimum, maximum and median filter values of said inputs; and
a program sequencer for providing an instruction for enabling said decision circuit to indicate at least one of said minimum, maximum and median filter values.

2. The processor with instruction based parallel median filtering of claim 1 in which said comparing circuit includes a comparator circuit for comparing each pair of the inputs.

3. The processor with instruction based parallel median filtering of claim 2 in which each said comparator circuit includes a subtractor circuit for subtracting each pair of inputs.

4. The processor with instruction based parallel median filtering of claim 3 in which greater and lesser members of each pair are indicated by the sign of the differences.

5. The processor with instruction based parallel median filtering of claim 1 in which said decision circuit includes a logic circuit responsive to the pattern of signs of the differences to indicate the median filter value.

6. The processor with instruction based parallel median filtering of claim 1 in which said decision circuit includes a logic circuit responsive to the pattern of signs of the differences to indicate the maximum, minimum and median filter values.

7. The processor with instruction based parallel median filtering of claim 1 in which said program sequencer provides one instruction for enabling said decision circuit to indicate one of said maximum, minimum and median filter values and another instruction to indicate the others of those values

8. The processor with instruction based parallel median filtering of claim 7 in which said instructions are compute pipeline independent.

9. The processor with instruction based parallel median filtering of claim 1 in which there are three inputs.

10. A method of instruction based parallel median filtering in a compute unit of a processor comprising:
sorting in parallel each combination of pairs of inputs into greater and lesser values;
determining from that sorting minimum, maximum and median filter values of the inputs; and
applying at least one instruction for enabling indication of at least one of the maximum, minimum, and median filter values.

11. The method of instruction based parallel median filtering in a compute unit of a processor of claim 10 in which there are three inputs.

12. The method of instruction based parallel median filtering in a compute unit of a processor of claim 10 which includes applying pipeline independent decomposed instructions for enabling indication of at least one of maximum, minimum, and median filter values in response to one instruction and the others of those values in response to another instruction.
